(19) United States
(12) Patent Application Publication
(10) Pub. No.: US 2004/0195545 A1
(43) Pub. Date: Oct. 7, 2004

(54) Composition for dusting coal mine surfaces

(76) Inventors: Frank T. Gay, Twinsburg, OH (US); Dontave D. Cowsette, Mayfield Heights, OH (US); Jeffrey T. Champa, Mentor, OH (US); Bradley S. Hulvey, Medina, OH (US)

Correspondence Address: JOSEPH G CURATOLO, ESQ., RENNER KENNER GREIVE BOBAK TAYLOR & WEBER, 24500 CENTER RIDGE ROAD, SUITE 280, WESTLAKE, OH, 44145, US

(21) Appl. No.: 10/785,916

(22) Filed: Feb. 24, 2004

Related U.S. Application Data
(63) Continuation-in-part of application No. 10/177,475, filed on Jun. 21, 2002, now Pat. No. 6,726,849.
(60) Provisional application No. 60/353,119, filed on Feb. 1, 2002.

(51) Int. Cl. C09K 3/22

(52) U.S. Cl. 252/88.1

(57) ABSTRACT

A foamed material is provided that is composed of water and limestone or other mineral dust suspended in a pregenerated foam and may be applied to the surface of a mine. Dry limestone dust or mineral dust is blended with pregenerated foam or foam generated in situ to produce a mass of foamed material that is highly vesicular but that is cohesive enough to be sprayed as a foamed mass against mine wall surfaces and ceilings. In another embodiment a dry powder formulation containing limestone dust, dry powder foaming agent and an additive that promotes the production of gas which effervesces upon contact with water can be used. Once applied, the low water content of the foamed material permits evaporation of the water, resulting in a dry mass of fine, loosely-cohesive, vesicular material that dusts readily.

### CROSS REFERENCE TO RELATED APPLICATIONS

This application is a continuation-in-part of U.S. Ser. No. 10/177,475 filed Jun. 21, 2002 (allowed), which claims priority from U.S. Provisional Application No. 60/353,119 filed Feb. 1, 2002, both of which are incorporated herein by reference.

### BACKGROUND

In underground coal mines, stone dusting of exposed rock surfaces is used to prevent and suppress fires caused by the ignition of coal dust and methane gas produced during the mining process. Stone dusting involves coating the surfaces of the mine with a fine-ground limestone dust. The dust adheres to the walls of the mine and prevents propagation of fires along exposed surfaces of unmined coal in the mine. In the event of the ignition of coal dust and gas within the mine, the concussion of an explosion and fire will cause the loosely adhering dust to fall from the surfaces of the mine to produce a limestone dust-air suspension that suppresses the propagation of flame and stops the fire.

In traditional stone dusting, a loose, poorly cohesive, dusty inert material is applied to the surfaces of walls and ceiling of the mine. In the event of a coal dust explosion, that the material is easily suspended into the air of the mine by the concussion. The traditional process of stone dusting is generally dusty and wasteful. Working personnel in the ventilation area have to be evacuated while the stone dusting procedure is performed because of the excessive amount of, respirable dust produced in the air of the mine during the stone dust application. The evacuation reduces the amount of time the mine can operate. In traditional practice, dust is applied by “flingers”. With this method, a substantial portion of the dust does not adhere to the surfaces of the mine and typically falls to the floor becoming wet and therefore inactive, leaving only a limited amount of material remaining usefully positioned on the walls and ceiling.

Kritchevsky, U.S. Pat. No. 2,195,573 discloses a method of laying dust which comprises contacting it with an aqueous solution of a condensation product of alkylolamine and a higher organic acid substance, preferably the higher fatty acids. This results in absorption of the aqueous material by the dust particles to a relatively substantial depth, with the result that the dust is prevented from becoming airborne when the surface is agitated.

Burns et al., U.S. Pat. No. 4,316,811 discloses a dust suppressant composition comprising polyethylene oxide crystalline thermoplastic, water soluble polymer, and the balance water. The dust suppressant composition can be applied by a variety of methods, such as spraying, immersion, painting, slurry and rinsing.

Kittle, U.S. Pat. No. 4,561,905 discloses a method of suppressing coal dust comprising the steps of diluting with water an emulsion comprising water, a surfactant, and oil which exhibits a tacky characteristic when in the form of a film in the absence of water. This mixture which is in the form of an emulsion is diluted and foamed. The foam is then sprayed into a mass of coal.

Roe, U.S. Pat. Nos. 4,971,720 and 5,143,645 disclose a foam formed from a solution of demineralized make-down water and foaming agent, wherein the foam is contacted with solid materials to suppress process dust emissions.

What is needed in the industry is a foamed composition that is used in the dusting of coal mine surfaces to prevent and suppress fires and explosions in underground coal mines without the detrimental side effect of wasteful excess airborne dust production.

### SUMMARY

A foamed material is provided that comprises limestone dust and pre-generated foam material; wherein the foamed material is non-cementitious and loosely cohesive; and wherein the pre-generated foam material comprises foaming agent and water.

A foamed material is also provided that comprises dust of at least one material selected from the group consisting of dolomite, magnesite, Class F fly ash, silica fume, gypsum, anhydrite, non-expansive clays, fine ground mine tailings, and mixtures thereof and pre-generated foam material; wherein the foamed material is non-cementitious and loosely cohesive; and wherein the pre-generated foam material comprises foaming agent and water.

A dry powder formulation is further provided that comprises limestone dust, a dry powder foaming agent and an additive that promotes the production of gas upon contact with water.

A dry powder formulation is provided that comprises dust of at least one material selected from the group consisting of dolomite, magnesite, Class F fly ash, silica fume, gypsum, anhydrite, non-expansive clays, fine ground mine tailings, and mixtures thereof; a dry powder foaming agent and an additive that promotes the production of gas upon contact with water.

When referring to a mine throughout this specification, it is also meant to include a stope.

### DETAILED DESCRIPTION

A novel foamed composition for prevention and suppression of fires in mines is provided, that comprises a pregenerated foam and the dust of limestone, dolomite, magnesite, Class F fly ash, silica fume, gypsum, anhydrite, non-expansive clays, fine ground mine tailings (dust) and mixtures thereof.

The pregenerated foam comprises activated foaming agent which is added to the limestone dust in a mixer; wherein the mixture is conveyed to a spray nozzle by either pumping or by pneumatic conveyance; and sprayed onto the mine surface, wherein the foamed material adheres to the mine surface of the mine and dehydrates or loses moisture to form a porous coating.

The foamed composition utilizes the loosely cohesive property of foamed material composed of a minor amount of water, with a fine grained mineral dust such as that obtained from limestone, dolomite, magnesite, Class F fly ash, silica fume, gypsum, anhydrite, non-expansive clays, or fine ground mine tailings, and mixtures thereof; suspended in a foam. Dry mineral dust is blended with pre-generated foam to produce a mass of material that is highly vesicular but that is cohesive and fluid enough to be pumped and sprayed as a foamed mass against mine wall surfaces and ceilings. The foamed material can be applied with a spraying device that allows the foamed mass to adhere to the surfaces. Because of the low density of the material, the material can be built up to any thickness suitable for the application.

The foamed composition produces no excessive airborne dust, thus eliminating the need to evacuate the personnel in the area during application. Its use is much cleaner and far less wasteful than normal stone dusting. After application, the low water content of the material permits evaporation of the water in the foamed mass, resulting in a non-setting dry mass of fine, loosely cohesive, vesicular material that dusts readily and has similar properties to that of the dry dust used in traditional stone dusting practice. This is in contrast to settable compositions which contain calcium carbonate or some other gas forming component and a cementitious binder which upon the addition of water undergoes a hardening or setting reaction.

When a cementitious binder is hydrated, the cement particles are surrounded by films of water. The anhydride phases initially react by the formulation of surface hydration products on each grain, and by dissolution in the liquid phase. The solution quickly becomes saturated with calcium and sulfate ions and the concentration of alkali cations increase rapidly. These reactions consume part of the unhydrated grains, but the reaction products tend to fill that space as well as some of the ordinary water-filled space. The hydration products at this stage are mostly colloidal (less the 0.1 micrometers) but some larger crystals of calcium aluminate hydrates, sulfoaluminate hydrate, and hydrogarnets eventually form bridges between the original grains, this is the stage of setting. Despite the low solubility and mobility of the silicate ions, growths of the silicate hydrates form in crystals and become incorporated into the calcium compound phases. Upon further hydration, the water filled spaces become increasingly filled with reaction products to produce hardening and strength development.

Water is used in the foam composition as a carrier for the dusting particle material, but not as an initiator and medium of cementitious particle chemical reaction. A set cementitious composition would not have the properties necessary to provide the properties of the foamed composition, namely wherein the dust particles fall from the surfaces of the mine to produce a limestone dust-air suspension that suppresses the propagation of flame and stop a fire.

Foaming agents that can be used with the foamed composition can be dry powder or liquid and may include alkanolamides, alkanolamines, alkylaryl sulfonates, polyethylene oxide-polypropylene oxide block copolymers, alkylphenol ethoxylates, carboxylates of fatty acids, ethoxylates of fatty acids, sulfonates of fatty acids, sulfates of fatty acids, sulfate esters of fatty alcohols, sulfate esters of fatty alcohol ethoxylates, for example laurel ether sulfates, fluorocarbon containing surfactants, olefin sulfonates, olefin sulfates, hydrolyzed proteins, and mixtures thereof. An example of a dry foaming agent suitable for use in the foamed composition includes, but is not limited to, an alpha olefin sulfonate powder sold under the trademark BIO-TERGE® from Stepan, Inc., Northfield, Ill. An example of a liquid foaming agent suitable for use in the foamed composition includes, but is not limited to, Rheocell® 30 from Master Builders Inc., Cleveland, Ohio. The dilution ratio of water to foaming agent may generally be about 20:1 (about 4.76% foaming agent in water) to about 60:1 (about 1.64%) but is preferably about 25:1 (about 3.8%) to about 35:1 (about 2.8%). Dilution ratios are a function of the composition of the foaming agent and are dictated by the typical use, and end use characteristics, of the foamed dust. Thus, the dilution rates of water to foaming agent may be considerably greater than those stated above; (for example, the dilution ratio of water to particular foaming agents may be in the thousands).

Alkanolamide foaming agents that may be used in the foamed composition include, but are not limited to, those having from about 12 to about 20 carbon atoms Alkanolamine foaming agents that may be used in the foamed composition include, but are not limited to, those having from about 12 to about 20 carbon atoms.

Alkylaryl sulfonate foaming agents that may be used in the foamed composition include, but are not limited to, those having one aryl group and having alkyl groups with about 12 to about 20 carbon atoms.

Polyethylene oxide-polypropylene oxide block copolymer foaming agents that may be used in the foamed composition include, but are not limited to, those having about 10 to about 20 units of each block.

Alkylphenol ethoxylate foaming agents that may be used in the foamed composition include, but are not limited to, those having an alkyl group of about 12 to about 20 carbon atoms.

Carboxylates of fatty acid foaming agents that may be used in the foamed composition include, but are not limited to, those in which the fatty acid moiety has about 12 to about 20 carbon atoms.

Ethoxylates of fatty acid foaming agents that may be used in the foamed composition include, but are not limited to, those in which the number of ethoxylate groups is about 10 to about 20 and the fatty acid moiety has about 12 to 20 carbon atoms.

Sulfonates of fatty acid foaming agents that may be used in the foamed composition include, but are not limited to, those in which the fatty acid moiety has about 12 to about 20 carbon atoms.

Sulfates of fatty acid foaming agents that may be used in the foamed composition include, but are not limited to, those in which the fatty acid moiety has about 12 to about 20 carbon atoms.

Sulfate esters of fatty alcohol foaming agents that may be used in the foamed composition include, but are not limited to, those in which the fatty alcohol moiety has about 12 to about 20 carbon atoms.

Sulfate esters of fatty alcohol ethoxylate foaming agents that may be used in the foamed composition include, but are not limited to, those in which the number of ethoxylate groups is about 10 to about 20 and the fatty alcohol moiety has about 12 to about 20 carbon atoms.

Fluorocarbon containing surfactant foaming agents that may be used in the foamed composition include, but are not limited to, those having about 12 to about 20 carbon atoms and one or more CH2 moieties are replaced by CF2 moieties.

Olefin sulfonate foaming agents that may be used in the foamed composition include, but are not limited to, those having about 12 to about 20 carbon atoms. In one embodiment the olefin sulfonate used in the foamed composition is alpha olefin sulfonate.

Olefin sulfate foaming agents that may be used in the foamed composition include, but are not limited to, those having about 12 to about 20 carbon atoms.

Hydrolyzed protein foaming agents that may be used in the foamed composition include, but are not limited to, the derivatized products of the hydrolysis of proteins. The relative molecular weight of the protein can be any molecular weight that provides for foaming action in a cementitious mixture. In one embodiment, the relative molecular weight ranges from about 10,000 to about 50,000. In another embodiment, hydrolyzed proteins are hydrolyzed gelatin, hydrolyzed collagen, and hydrolyzed proteins derived from blood. As an example but not a limitation of hydrolyzed gelatin is TG222 from Milligan & Higgins (Johnstown, N.Y.).

Other materials (including minerals) may be substituted for limestone as the dust component of the foamed composition and, may include fillers or replacements for limestone. Examples, but not limitations of the materials that could be used for the dust incorporated in an embodiment of the foamed composition are dolomite, magnesite, marble, Class F fly ash silica fume, gypsum, anhydrite, non-swelling clays, mine tailings and mixtures thereof. These materials or minerals are preferably water-insoluble, noncombustible, and may include organic or inorganic salts that are inert. The dust may also be composed of mixtures of the listed components. These powders or dusts do not substantially affect the stability of the foam that is added to the dry powder to produce the final foamed material. These dust materials are characterized by being easily incorporated into the foam to form the stable, fluid foamed mass. The fluid mass can be applied with little water and upon drying reverts to a dry, air dispersible powder necessary for the suppression of fire and explosion.

Further, any other additives that do not interfere with the fire prevention and suppression properties of the foamed composition may be added. These may include dispersants that facilitate the predampening or wetting-out of a dry dust material.

The density of the foamed dust material may generally be about 12 lb./cubic foot (192.2 kg/m³) to about 60 lb./cubic foot (961.1 kg/m³) but preferably is about 25 lb/cubic foot (400 kg/m³) to about 35 lb./cubic foot (560 kg/m³).

An advantage of applying the dust utilizing a foam carrier is that when the foam material is delivered such as by using a spray device, it allows the foam mass to adhere to the surfaces of the mine, enabling application of multiple layers until a desired thickness is achieved. Additionally, no excessive dust is produced during the application, thereby potentially eliminating the need to evacuate the mines during the process. The foamed material may exhibit water contents of about 8% to about 40%, but preferably are about 10% to about 15% water by weight of applied material. The actual dust content is a function of the rate of addition of the pregenerated foam to the dust, the density of the pregenerated foam, and the dilution rate of the foaming agent prior to the generation of the foam. After application, the low water content of the material permits rapid evaporation of the water, resulting in a dry mass of fine, partly cohesive vesicular material that dusts readily. The low water content is an amount of water effective to form the foamed material and incorporate the dust material.

The dust of limestone, dolomite, magnesite, Class F fly ash, silica fume, gypsum, anhydrite, non-expansive clays, fine ground mine tailings, and mixtures thereof, can be blended with the pregenerated foam at an underground station in the mine. To form the foamed material, the mixture is blended in a mobile tank. At the bottom of the tank can be a segmented auger screw that provides the mixing action needed to blend the foam with the dry powder. Preferably, a paddle mixer can be used that folds the pregenerated foam into the dry powder until the powder is blended with the foam as a homogeneous foamed material.

The mobile tank can be moved underground and positioned to any accessible area in the mine where the dusting activity may be required. Once at the position for application in the mine, a pump on or near the mobile tank is used to pump the foamed mixture through a hose and nozzle where it is applied to the walls and ceiling of the mine. Some of the foam structure is lost on impact with the wall. Because of the low water content of the foamed material, the loss of foam structure promotes rheological stiffening, making the mass sticky, and promoting adhesion to the surface and allowing build-up of the foamed material to a desired thickness. The velocity of the foamed material sprayed from the nozzle should not be so great as to destroy the foam structure of the applied foamed material entirely, but should allow the retention of a loose, fluffy foamed structure to retain the properties needed for the performance of the foamed material in the event of an explosion and mine fire.

In addition, if the foamed material is to be applied in more than one place, the material can be fabricated at a first location and pumped to stations within the mine. There, the material could be retained for use as needed without having to transport the material in large tanks for long distances throughout the mine.

As an example, but not a limitation, the foamed material can be applied by a continuous cavity pump, to pump the foamed material to a pneumatic application nozzle (such as a nozzle used for low velocity shotcrete and repair). The pneumatic application nozzle tends to break up the stream of foamed material as it enters the nozzle. The use of this nozzle allows adequate application of the foamed material onto the mine surface. The foamed material can additionally be applied using an “airless system”. The simplest form of an airless system can be the elimination of the nozzle and reliance only on the pressure produced by a continuous cavity pump to apply the foamed material.

In one embodiment, the foamed material is adapted from a shotcrete process, for spraying the foamed material onto a mine surface. Although this specification describes shotcrete applications for illustrative purposes, the foamed composition is applicable to any application in which a foamed material is to be conveyed to an application point and sprayed on a mine surface.

In another embodiment, a dry powder formulation is used which contains the dust of limestone, dolomite, magnesite, Class F fly ash, silica fume, gypsum, anhydrite, non-expansive clays, fine ground mine tailings, and mixtures thereof; a trace amount of a dry powder foaming agent (preferably about 0.05% to about 0.5% by dry weight of powder formulation) and a trace amount of an additive (preferably about 0.25% to about 1.0% by dry weight of powder formulation) that reacts with the dust to produce a of gas upon contact with water. The dry powder formulation can be sprayed onto a wet surface (mine surfaces coated with water) or sprayed together with water to a mine surface. When the dry powder is mixed with the water, the dry powder formulation effervesces to produce a foamed material. As an example but not a limitation, any water-soluble additive that produces a mild acidic solution when added to water and reacts with the carbonates in the limestone or other dust material to produce the gas for foaming can be added to the dry powder formulation as a dust or dry powder. The resulting acid reacts, for example, with the calcium carbonate and magnesium carbonate of limestone dust to produce a gas that foams the mixture. Gas producing additives which can be used with the foamed composition include but are not limited to aluminum sulfate and monoammonium phosphate.

In a further embodiment, a dry powder formulation is used which contains the dust of limestone, dolomite, magnesite, Class F fly ash, silica fume, gypsum, anhydrite, non-expansive clays, fine ground mine tailings, and mixtures thereof; a trace amount of a dry powder foaming agent; and, a trace amount of an additive that reacts with the dust to produce a small amount of gas. In one embodiment, the foamed material containing the dust is generated in a mixer prior to application. In another embodiment, a specialized nozzle allows dry formulated powder material to be transmitted pneumatically to the nozzle, where an inline mixer blends water with the dry powder, thereby initiating effervescence, and sprays the resulting foamed material onto a surface. As an example, but not a limitation, of a specialized nozzle, a long shotcrete nozzle commercially available from Pump Haus, Dallas, Tex., could be used which would provide adequate mixing of the material with water and permit foaming of the dry powder formulation within the nozzle.

Additionally, the definition of “dust” should be given the meaning as one of ordinary skill in the field would understand it. More particularly, the definition of dust by WEBSTER'S NEW UNIVERSAL UNABRIDGED DICTIONARY, Simon & Schuster, incorporated herein by reference, is “earth or any other matter so finely powdered and so dry that it is easily suspended in air; anything in the form of a fine powder.”

The foamed composition can be better understood by the following examples that describe certain embodiments of the foamed composition, but are not intended to limit the foamed composition:

### EXAMPLE 1

The material consisted of dry, ground limestone (standard raw material) with no water added. Pregenerated foam was produced from a 4% solution of Rheocell® 30 synthetic foaming agent (Master Builders, Inc., Cleveland, Ohio) in water, in a bench-top generator and added to the limestone in a Hobart® mixer for 15 seconds while the mixer was turning. The foam was folded into the dry-ground limestone to form a cohesive foamed mass of material that could be spread with a trowel. The foamed material was sprayed onto a rock surface using an air gun.

As the foamed material dried, it became dusty, less cohesive and powdery, but was adherent to a vertical or inverted surface. When the material had dried, it was confirmed that the material was similar to what would be expected in the in-place material as a dry applied rock dust. The water in the foam (17%-18% by mass) evaporated forming a relatively dense and cohesive layer of ground limestone that adhered to the rock surface and could dust readily.

### EXAMPLE 2

Dry ground limestone (a standard raw material) with no water added was placed in a paddle mixer. Pregenerated foam formed from a 5% solution of Rheocell® 30 synthetic foaming agent (Master Builders, Inc., Cleveland, Ohio) in water was added to the material in a paddle mixer for thirty seconds in several steps while the mixer was turning. The foam was folded into the dry ground limestone to form a cohesive foamed mass of material (foamed material). The foamed material was pumped using a continuous cavity pump with a pneumatic application nozzle and was sprayed at low pressure at velocity.

It was determined that the dust material had a density of 29.6 pounds per cubic foot (474 kg/m³) and could be spread with a trowel. Additionally, the foamed material could be sprayed at low pressure to produce a 1-inch (2.54 cm) thick layer of foamed material that retained a “foam-like” porous structure as it dried and adhered to the surface of the board or shotcrete to which it was applied. As the foamed material dried, it became dusty, less cohesive and powdery, but adhered to a vertical or inverted surface of a board. This test demonstrated, that the pregenerated foam is a usable carrier for the application of limestone dust to the wall and ceiling surfaces of a mine.

### EXAMPLE 3

Pregenerated foam formed from a 5% solution of Rheocell® 30 synthetic foaming agent (Master Builders, Inc., Cleveland, Ohio) in water was added to the mixer and the mixer was started. While the mixer was turning, limestone dust was added to the foam and blended. Additional pregenerated foam formed from a 5% solution of Rheocell® 30 synthetic foaming agent (Master Builders, Inc., Cleveland, Ohio) in water was added to produce a cohesive mass of ground limestone that could be pumped in a continuous cavity pump or a positive displacement pump.

The foamed material had a density of 28.28 pounds per cubic foot (453 kg/m³) and could be sprayed at low pressure to produce a 1-inch (2.54 cm) thick layer of foamed material that retained a “foam-like” porous structure as it dried and adhered to the surface of the board or shotcrete to which it was applied. As the porous foamed material dried, a dusty layer formed at the surface within about one hour of application. The foamed material displayed the same result as that of example 2, namely—excellent adherence to vertical, horizontal, and overhead surfaces and the ability to dust while remaining partly cohesive. Additionally, it was observed that as the foamed material was being sprayed, the material was less dusty than hand-applied limestone dust.

### EXAMPLE 4

Fifty pounds (22.6 kg) of dry, limestone dust was placed in a paddle mixer. Pregenerated foam formed from a 2.5% solution of Rheocell® 30 synthetic foaming agent (Master Builders, Inc., Cleveland, Ohio) in water was added to the material in a paddle mixer for thirty seconds in several steps while the mixer was turning. The foam was folded into the limestone dust to form a foamed mass of material (foamed material) with a cohesive and paste-like consistency. The foamed material was pumped and placed as in the previous examples using a continuous cavity pump with a pneumatic application nozzle to spray the foamed material.

The foamed material had a density that was heavier than in examples 1, 2 and 3 (4%-5% foaming agent) at 52 pounds per cubic foot (832 kg/m³) and took longer to dry. However, the foamed material could still be poured and pumped. It was sprayed at low pressure to produce a 1-inch (2.54 cm) layer of foamed material that retained a porous structure as it dried and adhered to the surface of the board or shotcrete to which is was applied. During application of the foamed material the pump was working harder than what was observed in the previous examples (1, 2 and 3) and there was a heat buildup in the nozzle. This was attributed to the increased dilution of the foaming agent (2.5%) resulting in a foamed material with a higher density. The foamed material was still successfully applied and formed a cohesive porous structure that could adhere to vertical, horizontal, and overhead surfaces, but a material that upon drying, dusted readily.

### EXAMPLE 5

Pregenerated foam formed from a 2.5% solution of Rheocell® 30 synthetic foaming agent (Master Builders, Inc., Cleveland, Ohio) in water was added to the mixer prior to the addition of 50 pounds (22.6 kg) of limestone dust. Additional pregenerated foam was added to the mixer as it folded in the limestone dust to produce a cohesive foamed material. This produced a cohesive fluid consistency in the foamed material. The foamed material was pumped and placed as in the previous placements using a continuous cavity pump with a pneumatic application nozzle to spray the foamed material.

The foamed material was less dense than what was observed in example 4. The density of the foamed material was 44.8 pounds per cubic foot (717.63 kg/m³) compared to the 52 pounds per cubic foot (832 kg/m³) of example 4. However, the foamed material still required more time to dry than observed in the less dense examples of 1, 2 and 3. The foamed material was sprayed at low pressure to produce a 1-inch thick layer of foamed material that retained a porous structure as it dried and adhered to the surface of the board or shotcrete to which it was applied. As in example 4, the pump was working harder than what was observed in examples 1, 2 and 3 with the result that there was a heat buildup in the nozzle. The foamed material was successfully applied and formed a cohesive structure that could adhere to vertical and horizontal, and overhead surfaces but a material that upon drying, dusted readily.

### EXAMPLE 6

Fifty pounds (22.6 kg) of dry limestone dust was placed in a mixer. Foam at a density of 2.8 pounds per cubic foot (44.8 kg/m³) was generated using a 3.3% solution of Rheocell® 30 synthetic foaming agent (Master Builders, Inc., Cleveland, Ohio) in water and added to the limestone dust in the mixer. The pregenerated foam was added to the dust in several steps to form a cohesive foamed material. The foamed material was transferred from the hopper by gravity flow to the pump where it was applied to a surface (vertical walls) using a pneumatic application nozzle.

The foamed material had a density of 35 pounds per cubic foot (560.6 kg/m³) with a water content of 20.84% by weight of foamed material. This produced a foamed material that pumped well, but the water content was greater than what is considered to be optimum. This was attributed to the elevated density of the foam before adding it to the dust. The foamed material was still successfully applied and adhered to a surface (vertical walls). The higher water content did not effect the ability of the foamed material to dry and form a cohesive porous structure.

### EXAMPLE 7

To form a foamed material, foam at a density of 2.8 pounds per cubic foot (44.8 kg/m³) was generated using a 3.3% solution of Rheocell® 30 synthetic foaming agent (Master Builders, Inc., Cleveland, Ohio) in water and added to fifty pounds (22.6 kg) of limestone dust in a paddle mixer. The pregenerated foamed material was fed from the hopper to the pump via gravity flow and applied to a surface using a pneumatic application nozzle, both with air assist and without.

The foamed material produced had a density that was lower than the previous examples (1-6) at 13.8 pounds per cubic foot (221 kg/m³) with a water content of 22.1% by weight of foamed material. The foamed material did not flow as well as at higher densities but it flowed adequately enough to be pumped through the pump. With the air assisted pneumatic application nozzle, the foamed material adhered well to a vertical, dry surface. Without the air assist, in the nozzle, the material was less dispersed and more of a well defined stream but still adhered to the dry vertical surface. The lower density of the material did not cause the material to flow down the vertical surface when applied. This allowed the foamed material to be layered to a desired depth and dry to form a crusty powdery surface within about one hour. The lower density observed in this example was attributed to the amount of foam that was added to the limestone dust during formation of the foamed material. This example demonstrates that even at low densities the foamed material is still capable of being properly applied and forms a material that dusts readily.

### EXAMPLE 8

Pregenerated foam with a density of 2.8 pounds per cubic foot (44.8 kg/m³) formed from a 3.3% solution of Rheocell® 30 synthetic foaming agent (Master Builders, Inc., Cleveland, Ohio) in water, was added to a mixer containing 50 pounds (22.6 kg/m³) of limestone dust. The foam was folded into the limestone dust to form a foamed mass of material. The foamed material was pumped and applied using a pneumatic application nozzle. The vertical surface to which it was applied had been wetted with water to simulate the water condensation that may be present in a mine during humid conditions.

The foamed material that was produced had a density of 17 pounds per cubic foot (272.3 kg/m³) with a water content of 24% by weight of the foamed material. The density is lower than what was seen in the previous examples (1-6) and was attributed to the amount of foam that was added to the limestone dust in the mixer. Even when applied to a wet vertical surface, the foamed material adhered well, both with the air assisted pneumatic application nozzle, which produced a wider spray of material, and without the air assist which produced a more well defined stream of material. This process produced an acceptable level of dust that would not require the shutdown of a mine when the material is being applied. The amount of time required for the foamed material to dry increased slightly due to the wetness of the surface during application. However, the development of a dusty crust occurred within about two hours of placement. This allows for the early potential of fire suppression due to the foamed material's ability to produce dust readily. The relatively low density of the material caused the flow properties of the foamed dust to be less easily pumped but did not adversely affect the spraying or adhesion of the material to the surface. As stated in Example 7, the example demonstrates that even at low densities the foamed material is still capable of being properly applied and dusts readily.

### EXAMPLE 9

A dry powder formulation was prepared that contained limestone, a trace amount of a dry powder foaming agent (alpha olefin sulfonate 0.1% by dry weight of the powder formulation) and a trace amount of an additive (0.5% aluminum sulfate by dry weight of the powder formulation) that reacts with limestone to produce a small amount of carbon dioxide gas. When the dry powder formulation was added to water it effervesced producing a foamed material that could adhere to rock surfaces and could be applied with a trowel. In this test, the dry powder formulation was sprayed onto a wet board.

The dry powder formulation adhered to the board and began effervescing to produce a loose foamy, porous veneer of foamed material. Once this material had dried, the material was soft, powdery and easily dislodged by air stream or by shock. It was therefore demonstrated that the foamed material can adhere to mine surfaces as a cohesive coating that can dust readily.

It will be understood that the embodiment(s) described herein is/are merely exemplary, and that one skilled in the art may make variations and modifications without departing from the spirit and scope of the foamed composition. All such variations and modifications are intended to be included within the scope of the foamed composition as described hereinabove. Further, all embodiments disclosed are not necessarily in the alternative, as various embodiments of the foamed composition may be combined to provide the desired result.

We claim:

1. A foamed material comprising:
a) limestone dust; and
b) pre-generated foam material;
wherein the foamed material is non-cementitious and loosely cohesive; and
wherein the pre-generated foam material comprises foaming agent and water.

2. The composition of claim 1, wherein the foaming agent comprises at least one of dry powder foaming agent or liquid foaming agent.

3. The composition of claim 1, wherein the water content is about 8% to about 40% of the foamed material.

4. The composition of claim 1 wherein the foamed material has a density of about 12 pounds per cubic foot to about 60 pounds per cubic foot.

5. The composition of claim 1 wherein the foamed material has a density of about 25 pounds per cubic foot to about 35 pounds per cubic foot.

6. The composition of claim 1 wherein the amount of the water to the foaming agent produces a dilution ratio of water to foaming agent from about 20:1 to about 60:1.

7. The composition of claim 1 wherein the amount of the water to the foaming agent produces a dilution ratio of water to foaming agent from about 25:1 to about 35:1.

8. The composition of claim 1, wherein the foaming agent comprises at least one of: alkanolamides, alkanolamines, alkylaryl sulfonates, polyethylene oxide-polypropylene oxide block copolymers, alkylphenol ethoxylates, carboxylates of fatty acids, ethoxylates of fatty acids, sulfonates of fatty acids, sulfates of fatty acids, fluorocarbon containing surfactants, olefin sulfonates, olefin sulfates, hydrolyzed proteins, or mixtures thereof.

9. The composition of claim 8, wherein the foaming agent comprises an alpha olefin sulfonate.

10. The composition of claim 8, wherein the foaming agent comprises laurel ether sulfate.

11. A dry powder formulation comprising:
a) limestone dust;
b) dry powder foaming agent; and
c) an additive that promotes the production of gas upon contact with water.

12. The composition of claim 11, wherein the dry powder foaming agent comprises at least one of: alkanolamides, alkanolamines, alkylaryl sulfonates, polyethylene oxide-polypropylene oxide block copolymers, alkylphenol ethoxylates, carboxylates of fatty acids, ethoxylates of fatty acids, sulfonates of fatty acids, sulfates of fatty acids, fluorocarbon containing surfactants, olefin sulfonates, olefin sulfates, hydrolyzed proteins, or mixtures thereof.

13. The composition of claim 12, wherein the foaming agent comprises an alpha olefin sulfonate.

14. The composition of claim 11, wherein the gas producing additive comprises at least one of: aluminum sulfate or monoammonium phosphate.

15. The composition of claim 11, wherein the gas producing additive is present in an amount from about 0.25% to about 1.0% based on dry weight.

16. The composition of claim 11, wherein the dry powder foaming agent is present in an amount from about 0.05% to about 0.5% based on dry weight.

17. A foamed material comprising:
a) dust of at least one material selected from the group consisting of dolomite, magnesite, Class F fly ash, silica fume, gypsum, anhydrite, non-expansive clays, fine ground mine tailings, and mixtures thereof; and
b) pre-generated foam material;
wherein the foamed material is non-cementitious and loosely cohesive; and
wherein the pre-generated foam material comprises foaming agent and water.

18. The composition of claim 17, wherein the foaming agent comprises at least one of dry powder foaming agent or liquid foaming agent.

19. The composition of claim 17, wherein the water content is about 8% to about 40% of foamed material.

20. The composition of claim 17 wherein the foamed material has a density of about 12 pounds per cubic foot to about 60 pounds per cubic foot.

21. The composition of claim 17 wherein the foamed material has a density of about 25 pounds per cubic foot to about 35 pounds per cubic foot.

22. The composition of claim 17 wherein the amount of water to the foaming agent produces a dilution ratio of water to foaming agent from about 20:1 to about 60:1.

23. The composition of claim 17 wherein the amount of water to the foaming agent produces a dilution ratio of water to foaming agent from about 25:1 to about 35:1.

24. The composition of claim 17, wherein the foaming agent comprises at least one of: alkanolamides, alkanolamines, alkylaryl sulfonates, polyethylene oxide-polypropylene oxide block copolymers, alkylphenol ethoxylates, carboxylates of fatty acids, ethoxylates of fatty acids, sulfonates of fatty acids, sulfates of fatty acids, fluorocarbon containing surfactants, olefin sulfonates, olefin sulfates, hydrolyzed proteins, or mixtures thereof.

25. The composition of claim 24, wherein the foaming agent comprises an alpha olefin sulfonate.

26. The composition of claim 24, wherein the foaming agent comprises laurel ether sulfate.

27. A dry powder formulation comprising:
a) dust of at least one material selected from the group consisting of dolomite, magnesite, Class F fly ash, silica fume, gypsum, anhydrite, non-expansive clays, fine ground mine tailings, and mixtures thereof;
b) dry powder foaming agent; and
c) an additive that promotes the production of gas upon contact with water.

28. The composition of claim 27, wherein the dry powder foaming agent comprises at least one of: alkanolamides, alkanolamines, alkylaryl sulfonates, polyethylene oxide-polypropylene oxide block copolymers, alkylphenol ethoxylates, carboxylates of fatty acids, ethoxylates of fatty acids, sulfonates of fatty acids, sulfates of fatty acids, fluorocarbon containing surfactants, olefin sulfonates, olefin sulfates, hydrolyzed proteins, or mixtures thereof.

29. The composition of claim 28, wherein the foaming agent comprises an alpha olefin sulfonate.

30. The composition of claim 27, wherein the gas producing additive comprises at least one of: aluminum sulfate or monoammonium phosphate.

31. The composition of claim 27, wherein the gas producing additive is present in an amount from about 0.25% to about 1.0% based on dry weight.

32. The composition of claim 27, wherein the dry powder foaming agent is present in an amount from about 0.05% to about 0.5% based on dry weight.
